(19) United States
(12) Patent Application Publication
(10) Pub. No.: US 2005/0271827 A1
(43) Pub. Date: Dec. 8, 2005

(54) Solar cell based on CulnS2 absorber layer prepared by chemical spray pyrolysis

(76) Inventors: Malle Krunks, Tallinn (EE); Arvo Mere, Tallinn (EE); Olga Kijatkina, Tallinn (EE)

Correspondence Address: c/o L.Christmann, 90 Blueberry Ln 30, Laconia, NH, 03246, US

(21) Appl. No.: 11/146,451

(22) Filed: Jun. 7, 2005

Related U.S. Application Data
(60) Provisional application No. 60/577,664, filed on Jun. 7, 2004.

(51) Int. Cl. H05H 1/26; B05D 5/12; B05D 7/00

(52) U.S. Cl. 427/446; 427/58; 427/421.1

(57) ABSTRACT

A superstrate configuration window layer/buffer layer/absorber layer solar cell structures were prepared either entirely by spray pyrolysis or in combination with chemical bath deposition (CBD) technique. Such solar cell comprises a glass substrate with transparent conductiong oxide layer on it, wide band gap window layer of ZnO or TiO2 on said oxide layer, prepared by chemical spray pyrolysis, CdS buffer layer on ZnO window layer, prepared by chemical spray pyrolysis, or by chemical bath deposition, or In—O—S buffer layer on TiO2 oxide layer, prepared by chemical bath deposition, and one or two layer CuInS2 absorber layer deposited on the buffer layer by chemical spray pyrolysis. A solar cell with output characteristics of Voc=456 mV, jSC=14.6 mA/cm2, FF=0.43 and efficiency of 2.9% was prepared with In—O—S buffer layer. A solar cell with CdS buffer layer was prepared entirely by spray pyrolysis, having output characteristics Voc=560 mV, jSC=8.2 mA/cm2, FF=0.5 and efficiency of 2.3%.

### CROSS REFERENCE TO RELATED APPLICATIONS

This application claims the benefit of U.S. provisional patent application No. 60/577,664, filed on Jun. 7, 2004, and incorporated herein by reference.

### BACKGROUND OF THE INVENTION

1. Technical Field

The invention relates to the field of manufacturing methods of CuInS₂ solar cells, more particularly to the field of manufacturing methods of superstrate configuration ZnO or TiO₂ window layer/buffer layer/CuInS₂ absorber layer solar cell structures either entirely by spray pyrolysis, or in combination with chemical bath deposition (CBD).

2. Background Art

The application of the compounds from I-III-VI2 group of semiconductors as absorber layers in photovoltaic solar cells has made considerable progress during the last years. CuInS₂ as a member of this group of materials has a direct band gap of 1.5 eV, a high absorption coefficient and nontoxic constituents and is, therefore, a promising candidate for photovoltaic applications.

CuInS₂ absorber layer based substrate configuration solar cells prepared by vacuum-based techniques have reached the efficiencies of 11.4% (see, e.g., M. Powalla, B. Dimmler, Solar Energy Mat. Solar Cells, 76 (2001) 337; S. Siebentritt, Thin Solid Films, 403-404 (2002) 1). During the last years the studies on the superstrate configuration cells (see K. Siemer, et al J. Klaer, I. Luck, J. Bruns, R. Klenk, D. Bräunig, Solar Energy Mat. Solar Cells, 67 (2001) 159) and low-cost thin film deposition methods as chemical bath deposition, spray chemical vapour deposition (see J. D. Harris, K. K. Banger, D. A. Scheiman, M. A Smith, M. H.-C. Jin, A. F. Hepp, Materials Science and Engineering B98 (2003) 150) and chemical spray pyrolysis (see M. H.-C. Jin, K. K. Banger, J. D. Harris, A. F. Hepp, 3rd World Conference on Photovoltaic Energy Conversion 2P-A8-21, 2003; A. Mere, O. Kijatkina, H. Rebane, J. Krustok, M. Krunks, Journal of Physics and Chemistry of Solids, 64 (2003) 2025; O. Kijatkina, M. Krunks, A. Mere, B. Mahrov, L. Dloczik, Thin Solid Films, 431 (2003) 105.) have been studied with the aim to reduce the production costs.

The spray pyrolysis is known as very promising method because large-area films with good uniformity may be prepared quickly at very low cost compared to other deposition methods. However, the efficiencies of cells are often recorded lower than 1% (see Harris above). The spray precursors specialities are supporting the use of superstrate configuration design for all layers sprayed solar cell. An additional benefit is that only one layer of glass is needed for superstrate configuration.

### SUMMARY OF THE INVENTION

According to the invention, superstrate configuration window layer/buffer layer/absorber layer solar cell structures were prepared either entirely by spray pyrolysis or in combination with chemical bath deposition (CBD) technique.

Such solar cell comprises a glass substrate with transparent conductiong oxide layer on it, wide band gap window layer of ZnO or TiO₂ on said oxide layer, prepared by chemical spray pyrolysis, CdS buffer layer on ZnO window layer, prepared by chemical spray pyrolysis, or by chemical bath deposition, or In—O—S buffer layer on TiO₂ oxide layer, prepared by chemical bath deposition, and one or two layer CuInS₂ absorber layer deposited on the buffer layer by chemical spray pyrolysis. A solar cell with output characteristics of Voc=456 mV, j_{SC}=14.6 mA/cm², FF=0.43 and efficiency of 2.9% was prepared with In—O—S buffer layer. A solar cell with CdS buffer layer was prepared entirely by spray pyrolysis, having output characteristics Voc=560 mV, j_{SC}=8.2 mA/cm², FF=0.5 and efficiency of 2.3%.

### BRIEF DESCRIPTION OF THE DRAWINGS

FIG. 1: Barrier height of p-n junction in solar cells depending on the Cu/In ratio in absorber layer spray solution;

FIG. 2: I-V curve of the solar cell based on In—O—S buffer by CBD and CuInS₂ by spray pyrolysis.

FIG. 3: The solar cell manufactured according to present invention.

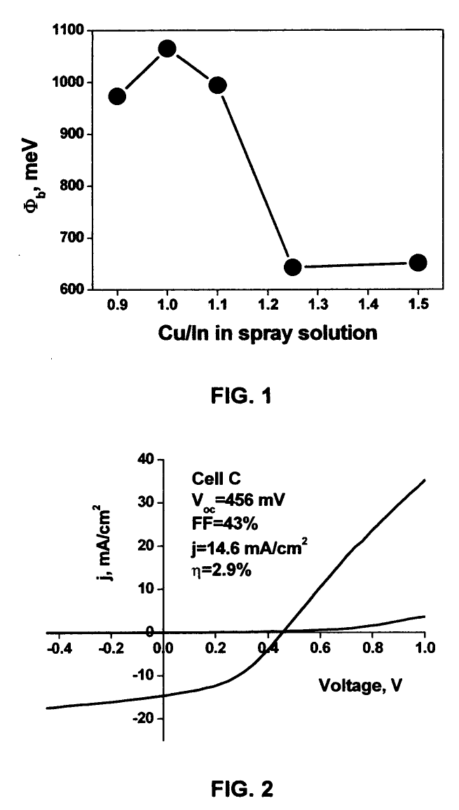

### DETAILED DESCRIPTION OF THE INVENTION

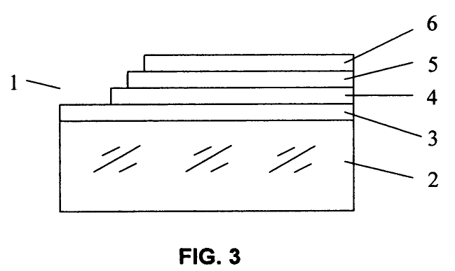

According to the invention, a superstrate solar cell is manufactured. Such solar cell 1 (see FIG. 3) comprises a glass substrate 2 with a TCO (transparent conductive oxide) layer 3 on it, a window layer 4 on the TCO layer, a buffer layer 5 on the window layer and absorber layer 6 on the buffer layer. A back contact is connected to the absorber layer. The superstrate structure is illuminated through the glass. Commercially available glass substrates with TCO layers are used to manufacture a solar cell according to present invention.

A method for manufacturing a superstrate solar cell according to one embodiment comprises:
creating a window layer comprising TiO₂ on the TCO layer, by chemical spray pyrolysis to form an underlayer for the buffer layer;
creating the buffer layer on the underlayer, the buffer layer comprising InₓO_{y}S_{z}, deposited from the aqueous solution comprising indium chloride (InCl₃) and thioacetamide (CH₃CSNH₂) by chemical bath deposition; and
creating the absorber layer comprising CuInS₂ on the buffer layer by chemical spray pyrolysis.

TCO layer according to this embodiment preferably comprises SnO₂.

A method according to another embodiment of the invention comprises:
creating two-layer window layer, first layer comprising ZnO:In prepared by chemical spray pyrolysis from the isopropoxide aqueous solution, comprising Zn(CH₃COO)₂ and InCl₃, and second layer comprising ZnO, prepared by chemical spray pyrolysis from the isopropoxide aqueous solution, comprising Zn(CH₃COO)₂ to form an underlayer for the buffer layer;
creating the buffer layer, comprising CdS, on the underlayer deposited from the aqueous solution, comprising CdCl₂ and SC(NH₂)₂;
annealing the structure in a reducing or inert atmosphere after the deposition of the buffer layer and subsequently slowly cooling down the structure.
creating the absorber layer comprising CuInS₂ on the buffer layer by chemical spray pyrolysis.

In₂O₃ (ITO) covered glass substrates are preferably used according to this method.

A method for manufacturing a superstrate solar cell according to third embodiment of the invention comprises:
creating two-layer window layer, first layer comprising ZnO:In prepared by chemical spray pyrolysis from the isopropoxide aqueous solution, comprising Zn(CH₃COO)₂ and InCl₃, and second layer comprising ZnO, prepared by chemical spray pyrolysis from the isopropoxide aqueous solution, comprising Zn(CH₃COO)₂ to form an underlayer for the buffer layer;
creating the buffer layer, comprising CdS, on the underlayer deposited from the aqueous solution, comprising CdCl₂ and SC(NH₂)₂; and
creating a first absorber layer, comprising CuInS₂ on the buffer layer by chemical spray pyrolysis from a first aqueous solution, comprising Cu, In and S precursors, whereas the solution is slightly Cu-poor; and
creating a second absorber layer, comprising CuInS₂ on the first absorber layer by chemical spray pyrolysis from a second aqueous solution, comprising Cu, In and S precursors, whereas the solution is slightly Cu-rich.

The invention is now described with the following examples.

### EXAMPLE 1

Superstrate solar cell containing SnO₂ as a TCO layer, TiO₂ window layer, In—O—S buffer layer and CuInS₂ absorber layer. Commercial TCO glass was used (TEC8 from Hartford Glass, sheet resistance 8 Ω/?) TiO₂ layer was prepared from precursor solution, prepared by adding 2.84 g of titanium(IV)isopropoxide (TTIP) to 46 ml EtOH, and adding acetylacetone (AcAc) to set the molar ratio of TTIP:AcAc=1:1 (It all results in molar ratios of TTIP:AcAc:EtOH=1:1:100 in spray solution). TiO₂ layer with thickness about 80-100 nm was prepared by pulsed spray deposition onto the heated TCO glass at 450° C. Compressed air was used as carrier gas. As-sprayed film was annealed for 30 minutes at 500° C. in air.

In—O—S buffer layer was prepared by chemical bath deposition from an aqueous solution containing indium chloride (InCl₃) and tioacetamide (CH₃CSNH₂). Molar ratio of InCl₃:(CH₃CSNH₂) is 1:4, concentration of InCl₃ is 25×10⁻³ mol/l, Acidity of solution pH=2 (by addition of CH₃COOH), bath temperature 70° C., deposition time 60 min (note that deposition time 40-60 minutes can be used, whereas an energy bandgap of the In—O—S buffer layer is about 2.35 to about 2.9 eV, preferably about 2.5 eV).

Absorber layer comprising CuInS₂ was prepared by chemical spray pyrolysis from aqueous solution comprising CuCl₂, InCl₃ and SC(NH₂)₂ whereas molar ratios of CuCl₂:InCl₃:SC(NH₂)₂ is from 0.9:1:3 to 1.1:1:3.15 (preferably 1:1:3). Concentration of CuCl₂ in aqueous solution was 2×10−3 mol/l, the aqueous solution in amount of 50 ml was sprayed onto the heated substrated using the spray rate of 2.0 ml/min. The film growth temperature was adjusted to 340° C. Nitrogen was used as a carrier gas. Conductive carbon paste (S=2-10 mm²) was used as electrode to CuInS₂

The solar cell according to example 1 has the following characteristics: barrier height 1250 meV, Voc=456 mV, j_{SC}=14.6 mA/cm², FF=0.43 and efficiency of 2.9% (see also FIG. 2).

### EXAMPLE 2

Doped In₂O₃ (ITO) covered glass with thickness of 1.1 mm (sheet resistance 30 Ω/?) was used to manufacture a superstrate solar cell. ZnO:In window layer was created on the ITO by chemical spray pyrolysis from Zn-acetate (Zn(CH₃COO)₂) dissolved in deionized water, concentration of zinc salt in spray solution (H₂O:Isopropanol=2:3 by volume) is 0.2 mol/l, volume 50 ml, Indium was added from InCl₃ in amount of 1 atom % (In/Zn=1 at. %). Deposition temperature was 420° C. and compressed air was used as carrier gas.

Thereafter, ZnO layer was created on ZnO:In layer by chemical spray pyrolysis from Zn-acetate dissolved in deionized water, concentration of zinc salt in spray solution (H₂O:Isopropanol=2:3 by volume) is 0.2 mol/l, volume 15 ml and at solution deposition rate 5.0 ml/min.

CdS buffer layer was created on the window layer by spray from aqueous solution comprising CdCl₂ and SC(NH₂)₂ at molar ratio 1:2 with concentration of CdCl₂ 10 mmol/l, at growth temperature 380° C. The amount of spray solution was 25 ml, solution deposition rate 2.0 ml/min. Nitrogen was used as a carrier gas.

Thereafter, the structure was annealed in low vacuum (at approximately 1 Pa) at 400° C. for 5 minutes, followed by slowly cooling down.

Thereafter, a first CuInS₂ absorber layer was created on the buffer layer principally as in Example 1 (Cu:In:S=0.9:1:3, 15 ml) and a second CuInS₂ layer on the first layer also principally as in Example 1 (Cu:In:S=1.25:1.3:3.15, 50 ml).

The solar cell according to example 2 has Voc=560 mV, j_{SC}=8.2 mA/cm², FF=0.5 and efficiency of 2.3%. Similar cell was prepared without annealing the structure, whereas Voc=504 mV, j_{SC}=6.9 mA/cm², FF=0.5 and efficiency of 1.75%. Thus, annealing of the buffer layer can be used to increase both Voc and j_{SC}.

Although this invention is described with respect to a set of preferred aspects and embodiments, modifications thereto will be apparent to those skilled in the art. Therefore, the scope of the invention is to be determined by reference to the claims that follow.

1. A method for manufacturing a superstrate solar cell, comprising a glass with transparent conducting oxide layer on it, a window layer, comprising TiO₂ on the conducting oxide layer, a buffer layer, an absorber layer comprising CuInS₂, the method comprising:
creating the window layer on the transparent conducting oxide layer by chemical spray pyrolysis to form an underlayer for the buffer layer;
creating the buffer layer on the underlayer, the buffer layer comprising InₓO_{y}S_{z}, deposited from the aqueous solution comprising InCl₃ and thioacetamide (CH₃CSNH₂) by chemical bath deposition; and
creating the absorber layer on the buffer layer by chemical spray pyrolysis.

2. A method as in claim 1, whereas the window layer is deposited from a solution comprising Titanium(IV) isopropoxide (TTIP), Acetylacetone (AcAc) and ethanol (EtOH).

3. A method as in claim 2, whereas the TTIP/AcAc/EtOH molar ratio is 1/1/100 and a growth temperature is between about 300° C. to about 550° C.

4. A method according to claim 3, whereas the absorber layer is prepared from an acqueous solution, comprising CuCl₂, InCl₃ and thiourea (tu), whereas a molar ratio of Cu/In is between about 0.9 and about 1.1 and Cu/tu molar ratio is about 1/3 to 1/3.15 and growth temperature between about 300 and about 380° C.

5. A method for manufacturing a superstrate solar cell, comprising a glass with transparent conducting oxide layer on it, a window layer, comprising ZnO, a buffer layer, an absorber layer comprising CuInS₂, the method comprising:
creating the ZnO:In window layer on the transparent conducting oxide layer by chemical spray pyrolysis from the isopropoxide aqueous solution, comprising Zn(CH₃COO)₂ and InCl₃ and creating Zn:O layer on said ZnO:In layer from the isopropoxide aqueous solution, comprising Zn(CH₃COO)₂ to form an underlayer for the buffer layer;
creating the buffer layer, comprising CdS, on the underlayer deposited from the aqueous solution, comprising CdCl₂ and SC(NH₂)₂; and
creating the absorber layer on the buffer layer by chemical spray pyrolysis.

6. A method as in claim 5, whereas the buffer layer is deposited by chemical spray pyrolysis and Cd/S molar ratio in the aqueous solution is from about 1/1 to about 1/2 and the method additionally comprises a step of annealing the structure in a reducing or inert atmosphere the structure after the deposition of the buffer layer and slowly cooling down the structure.

7. A method as in claim 6, whereas Cd/S molar ratio is about 1/2 and a growth temperature is between about 380° C. to about 420° C.

8. A method as in claim 7, whereas the growth temperature is about 400° C.

9. A method as in claim 5, whereas the buffer layer is deposited by chemical bath deposition, whereas the bath temperature is about 80° C. and the solution additionally comprises NH₄Cl and NH₄OH.

10. A method as in claim 9, the method additionally comprises a step of annealing in reducing or inert atmosphere the structure after the deposition of the buffer layer, and slowly cooling down the structure.

11. A method for manufacturing a superstrate solar cell, comprising a glass with transparent conducting oxide layer on it, the method comprising:
creating a window layer, comprising ZnO on the transparent conducting oxide layer by chemical spray pyrolysis from the isopropoxide aqueous solution, comprising Zn(CH₃COO)₂ to form an underlayer for the buffer layer;
creating the buffer layer, comprising CdS, on the underlayer deposited from the aqueous solution, comprising CdCl₂ and SC(NH₂)₂; and
creating a first absorber layer, comprising CuInS₂ on the buffer layer by chemical spray pyrolysis from a first aqueous solution, comprising Cu, In and S precursors, whereas the solution is slightly Cu-poor; and
creating a second absorber layer, comprising CuInS₂ on the first absorber layer by chemical spray pyrolysis from a second aqueous solution, comprising Cu, In and S precursors, whereas the solution is slightly Cu-rich.

12. As in claim 11, whereas Cu:In:S molar ratio in the first aqueous solution is about 0.9:1:3.

13. As in claim 12, whereas Cu:In:S molar ration in the second aqueous solution is about 1.25:1:3.15.
